(19) United States
(12) Patent Application Publication
(10) Pub. No.: US 2026/0058185 A1
(43) Pub. Date: Feb. 26, 2026

(54) BATTERY MANUFACTURING APPARATUS AND CONTROLLING METHOD OF THE SAME

(71) Applicant: SK On Co., Ltd., Seoul (KR)

(72) Inventors: Byeong Hyeon PARK, Daejeon (KR); Min Seong KIM, Daejeon (KR); Yong Seok LEE, Daejeon (KR); Jae Myoung LEE, Daejeon (KR); Dong Ha HWANG, Daejeon (KR)

(21) Appl. No.: 19/266,121

(22) Filed: Jul. 10, 2025

(30) Foreign Application Priority Data
Aug. 20, 2024 (KR) 10-2024-0111272

(51) Int. Cl. H01M 10/04; H01M 10/615; H01M 50/627

(52) U.S. Cl. CPC H01M 10/0404; H01M 10/049; H01M 10/615; H01M 50/627

(57) ABSTRACT

The present disclosure relates to a battery manufacturing apparatus and a method of controlling thereof, which comprises a supporting portion forming a receiving space for receiving a battery cell under assembly, the battery cell including an electrode assembly and a case including the electrode assembly therein; an injector including an injection pipe for moving an electrolyte to inject the electrolyte into the case; and a heater spaced apart from the supporting portion for heating the battery cell under assembly and the injector.

### CROSS-REFERENCE TO RELATED PATENT APPLICATION

The present application claims priority under 35 U.S.C. § 119 (a) to Korean patent application number 10-2024-0111272 filed on Aug. 20, 2024, in the Korean Intellectual Property Office, the entire disclosure of which is incorporated by reference herein.

### BACKGROUND OF THE INVENTION

### 1. Field

The present disclosure relates to a battery manufacturing apparatus and a controlling method thereof. More particularly, it relates to a battery manufacturing apparatus for injecting electrolyte and a controlling method thereof.

### 2. Description of the Related Art

A conventional battery cell is manufactured by a process of receiving an electrode assembly in a shell or case, injecting an electrolyte, and sealing the shell or the case. Upon injection of the electrolyte, the electrode assemblies received in the interior of the outer material are impregnated with the electrolyte. Thus, the electrode assembly is impregnated with the electrolyte injected.

Furthermore, due to the close contact not only between the outer material and the electrode assembly, but also between the first electrode, the second electrode, and the separator included in the electrode assembly, it is not easy for the electrolyte to be impregnated into the electrode assembly. Therefore, it is necessary to increase the impregnability of the electrolyte.

First, according to one aspect of the present disclosure, the impregnability of the electrolyte may be increased.

Second, in another aspect of the present disclosure, the productivity of battery cells may be improved.

On the other hand, the battery cell manufactured using the battery manufacturing apparatus and the controlling method according to the present disclosure can be widely applied in the field of green technology such as electric vehicle, battery charging station, energy storage system (ESS), photovoltaics, wind power, etc. that utilize batteries. In addition, the battery cell manufactured using the battery manufacturing apparatus and the controlling method according to the present disclosure can be used for eco-friendly mobility, including electric vehicles and hybrid vehicles to prevent climate change by suppressing air pollution and greenhouse gas emissions.

### SUMMARY OF THE INVENTION

A battery manufacturing apparatus according to an embodiment of the present disclosure may comprise: a supporting portion forming a receiving space for receiving a battery cell under assembly, the battery cell including an electrode assembly and a case including the electrode assembly therein; an injector including an injection pipe for moving an electrolyte to inject the electrolyte into the case; and a heater spaced apart from the supporting portion for heating the battery cell under assembly and the injector.

In an embodiment, the heater may irradiate light of an infrared wavelength range toward the battery cell under assembly and the injector.

In an embodiment, the supporting portion may include a support bottom portion forming the bottom surface of the receiving space and a support side portion forming the side surface of the receiving space.

In an embodiment, the battery manufacturing apparatus may further comprise: a reflective film laminated on an inner surface of the receiving space.

In an embodiment, the supporting portion may include a support bottom portion forming the bottom surface of the receiving space and a support side portion forming the side surface of the receiving space, and the reflective film may be coated on the support side portion and the support bottom portion.

In an embodiment, the injection pipe may be in the shape of a coil.

In an embodiment, the injector may further include an injection nozzle connected to the injection pipe and supplies the electrolyte into the case receiving the electrode assembly.

A method of controlling a battery manufacturing apparatus according to another embodiment of the present disclosure may comprise: a step of arranging a battery cell under assembly, which includes an electrode assembly and a case including the electrode assembly therein, in a receiving space formed by a supporting portion; a step of operating an injector for injecting an electrolyte into the case and a heater for heating the battery cell under assembly; and a step of injecting the electrolyte into the case through the injector.

In another embodiment, the method of controlling a battery manufacturing apparatus may further comprise: a step of making the temperature of the electrolyte reach a preset target temperature range after the step of injecting the electrolyte.

In another embodiment, the target temperature range is 40° C. or more but less than 60° C.

In another embodiment, the method of controlling a battery manufacturing apparatus may further comprise: a step of moving the battery cell under assembly for charging and discharging after the step of making the temperature of the electrolyte reach a preset target temperature range.

In another embodiment, the method of controlling a battery manufacturing apparatus may further comprise: a step of coupling a cap assembly to the case to cover an opening formed on a side of the case facing the direction in which the electrolyte is injected prior to the step of moving the battery cell under assembly for charging and discharging.

In another embodiment, the step of moving the battery cell under assembly for charging and discharging may include a step of cooling the battery cell under assembly to a temperature lower than the target temperature range.

In another embodiment, the method of controlling a battery manufacturing apparatus may further comprise: a step of coupling a cap assembly including an injection hole to the case to cover an opening formed on a side of the case prior to the step of injecting the electrolyte into the case.

In another embodiment, the heater may heat the battery cell under assembly to a preset first temperature in the step of operating the heater.

In another embodiment, the method of controlling a battery manufacturing apparatus may further comprise: a step of making the temperature of the electrolyte reach a target temperature range lower than the preset first temperature after the step of injecting the electrolyte.

In accordance with one aspect of the present disclosure, the impregnability of the electrolyte can be increased.

In accordance with another aspect of the present disclosure, the productivity of battery cells can be improved.

### BRIEF DESCRIPTION OF THE DRAWINGS

FIG. 1 is an example of a battery cell manufactured by a battery manufacturing apparatus according to the present disclosure.

FIG. 2 illustrates a cross-sectional view of a battery cell manufactured by a battery manufacturing apparatus according to the present disclosure.

FIG. 3 illustrates another cross-sectional view of a battery cell manufactured by a battery manufacturing apparatus according to the present disclosure.

FIG. 4 illustrates a portion of a manufacturing process for a battery cell according to the present disclosure.

FIG. 5 is an example of a battery manufacturing apparatus according to the present disclosure.

FIG. 6 is another example of a battery manufacturing apparatus according to the present disclosure.

FIG. 7 is a control block diagram of a battery manufacturing apparatus according to the present disclosure.

FIG. 8 is a flowchart illustrating a controlling method of a battery manufacturing apparatus according to the present disclosure.

### DETAILED DESCRIPTION

Embodiments of the present disclosure will be described in detail hereinafter with reference to the accompanying drawings. The apparatus configurations and controlling methods described herein are intended to illustrate embodiments of the present disclosure and are not intended to limit the scope of the present disclosure, and like reference numerals used throughout the specification refer to like components.

The use of terms such as “first,” “second,” “third,” and the like to precede components referred to herein is intended to avoid confusion as to the components to which they refer and is not intended to indicate any order, importance, or master-servant relationship among the components. For example, it is possible to practice an invention that includes only the second component without the first component.

As used in this disclosure, expressions in the singular include the plural unless the context clearly indicates otherwise.

As used herein, the terms battery, secondary battery, or cell are used interchangeably with battery cell.

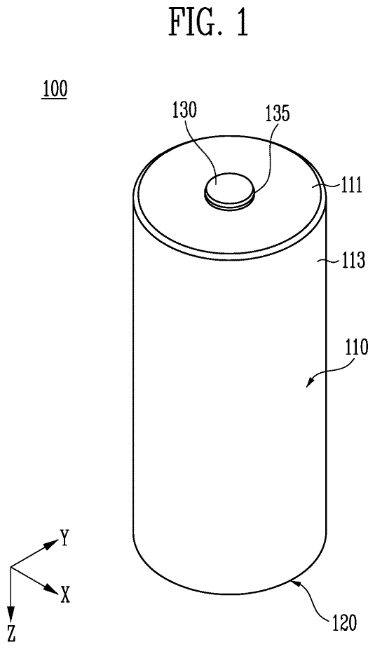

FIG. 1 is an example of a battery cell manufactured by a battery manufacturing apparatus according to the present disclosure.

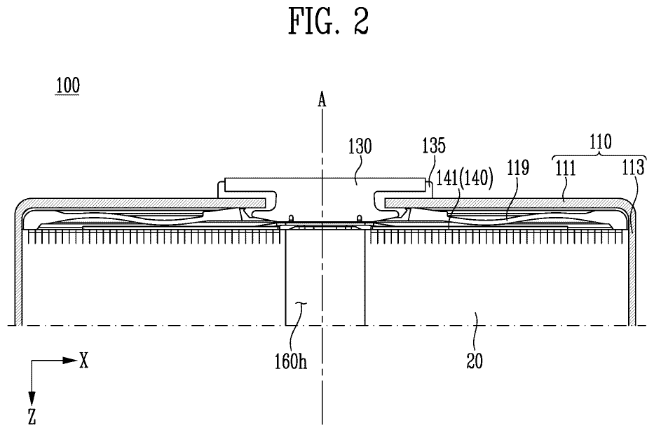

Referring to FIG. 1, a battery cell 100 manufactured by a battery manufacturing apparatus according to the present disclosure may include a case 110 that internally accommodates an electrode assembly 20 (see FIG. 2) that produces or stores electrical energy, and a terminal portion 130 that projects outwardly and is electrically connected to the electrode assembly 20.

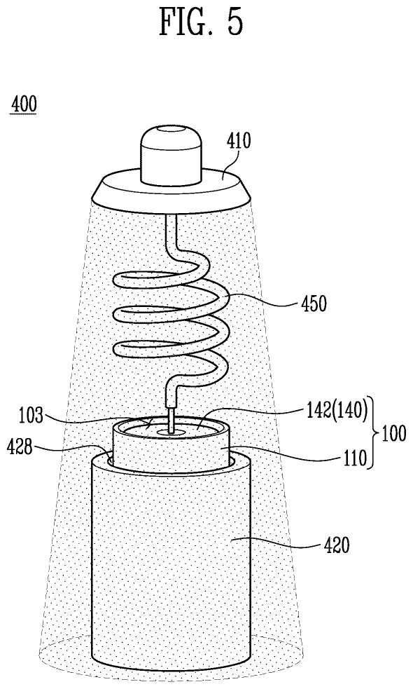

The case 110 may form the outline of the battery cell 100. While FIG. 1 illustrates a cylindrical battery cell 100, the shape of the battery cell is not limited to this, i.e., the battery manufacturing apparatus 400 (see FIG. 5) according to the present disclosure is applicable to various other shapes of battery cells, including prismatic and pouch battery cells.

The case 110 may include an opening 103 (see FIG. 5) through which the electrode assembly 20 may be received. Referring to FIG. 1, the opening 103 may be located on an opposite side of the terminal portion 130. Furthermore, the battery cell 100 may include a cap assembly 120 that is coupled to the case 110 to close the opening 103.

In other words, the case 110 may be formed by deep drawing a circularly shaped disk, so that one end of the case 110 is open and the other end of the case 110 is closed. The case 110 may include a side portion 113 forming a circumferential surface and a flat portion 111 forming the other end of the case 110.

The terminal portion 130 may be located in the opening or in the flat portion 111 facing the cap assembly 120. The battery cell 100 may further comprise a through-hole (not shown) through the flat portion 111, and the terminal portion 130 may be inserted into the through-hole.

Since the terminal portion 130 has electrical polarity, the battery cell 100 may further comprise a gasket 135 between the case 110 and the terminal portion 130 for electrical isolation from the case 110.

FIG. 2 illustrates a cross-sectional view of a battery cell manufactured by a battery manufacturing apparatus according to the present disclosure.

More specifically, FIG. 2 illustrates a cross-sectional view of a region adjacent to the flat portion 111.

The battery cell 100 may receive an electrode assembly 20 therein. The electrode assembly 20 may be in the form of corresponding to the cylindrical case 110 or the side portion 113, i.e., the electrode assembly 20 may be in the form of a roll wound with a first electrode, a second electrode and a separator located between the first electrode and the second electrode. Thus, the case 110 and the electrode assembly 20 may share a central axis A.

In the present disclosure, the first electrode may refer to any one of an anode and a cathode, and the second electrode may refer to any other of an anode and a cathode.

The electrode assembly 20 may include a center-hole 160h in a region adjacent to the central axis A. This is in consideration of the degree of bending (i.e., radius of curvature) of the electrode assembly 20 to prevent breakage when the electrode assembly 20 is wound.

The battery cell 100 may include a current collector 140 electrically connecting the terminal portion 130 and the electrode assembly 20. The current collector 140 may electrically connect the first electrode and the terminal portion 130.

To this end, the current collector 140 may be coupled by welding with the first electrode and the terminal portion 130.

For electrical insulation between the flat portion 111 and the current collector 140, the battery cell 100 may include an insulating cover 119 between the flat portion 111 and the current collector 140.

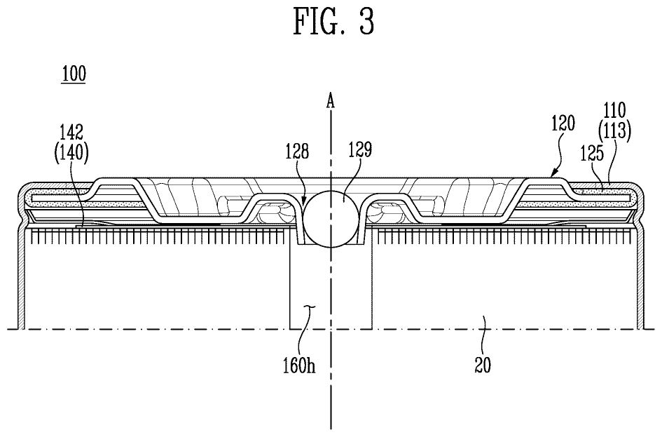

FIG. 3 illustrates another cross-sectional view of a battery cell manufactured by a battery manufacturing apparatus according to the present disclosure.

More specifically, FIG. 3 illustrates a cross-sectional view of a region adjacent to the cap assembly 120.

The battery cell 100 may further comprise a current collector 140 between the cap assembly 120 and the electrode assembly 20. More specifically, referring to FIGS. 2 and 3, the current collector 140 may include a first current collector 141 electrically connecting the first electrode to the terminal portion 130 and a second current collector 142 electrically connecting the second electrode to the side portion 113.

Alternatively, however, the second current collector 142 may electrically connect the cap assembly 120 and the electrode assembly 20.

Further, the battery cell 100 may further comprise an insulator 125 for electrically insulating the cap assembly 120 and the case 110.

The cap assembly 120 may be disk-shaped about the central axis A. Further, the cap assembly 120 may comprise an injection hole 128 through the cap assembly 120 along the central axis A.

The injection hole 128 may be used for injecting electrolyte into the case 110. The battery cell 100 may further comprise a closure portion 129 in the form of a sphere to close the injection hole 128 after injection of the electrolyte.

The electrolyte may be injected through the injection hole 128 after the cap assembly 120 is coupled to the case 110, but before the injection hole 128 is closed. Alternatively, however, the electrolyte may be injected into the case 110 through the opening 103 before the cap assembly 120 is coupled thereto.

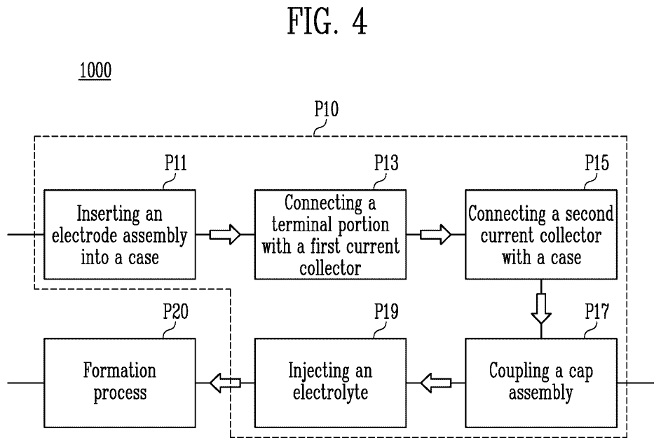

FIG. 4 illustrates a portion of a manufacturing process for a battery cell according to the present disclosure.

More specifically, FIG. 4 schematically illustrates a portion of a battery cell manufacturing process 1000 for manufacturing the battery cell 100 described in FIGS. 1 to 3.

To manufacture the battery cell 100, the battery cell manufacturing process 1000 according to the present disclosure may include a process P10 for mechanically assembling the battery cell 100 and a formation process P20 or a charge-discharge process for charging and discharging the battery cell 100 to activate the battery cell 100.

The process P10 of mechanically assembling the battery cell 100 may include a process P11 of inserting the electrode assembly 20 into a cylindrical shaped case 100 (see FIG. 1) with an opening formed on a side of the case, a process P13 of connecting the terminal portion with the first current collector 141, and a process P15 of connecting the second current collector 142 with the case 110.

Prior to the process P11 of inserting the electrode assembly 20 into the case, the battery cell manufacturing process 1000 according to the present disclosure may perform a process (not shown) of assembling the electrode assembly 20 with the first current collector 141 and the second current collector 142.

The process of assembling the electrode assembly 20 with the first current collector 141 and the second current collector 142 may utilize welding performed by ultrasonic or laser.

The process P10 of mechanically assembling the battery cell 100 may include a process P17 of coupling the cap assembly 120 to the case 110 and a process P19 of injecting the electrolyte into the case 110.

The process P17 of coupling the cap assembly 120 to the case 110 and the process P19 of injecting the electrolyte into the case 110 may be reversed in order.

For example, the manufacturing process 1000 of a battery cell according to the present disclosure may first perform a process P17 of coupling the cap assembly 120 to the case 110, and then perform a process P19 of injecting the electrolyte. In this case, the opening 103 is covered by the cap assembly 120, so that the electrolyte can be injected through the injection hole 128.

In another example, the battery cell manufacturing process 1000 according to the present disclosure may perform the process P19 of injecting the electrolyte and then perform the process P17 of coupling the cap assembly 120 to the case 110. Thus, the manufacturing process 1000 of a battery cell according to the present disclosure may be able to inject the electrolyte through the opening 103.

In any case, prior to the chemical process P20 of charging and discharging the battery cell 100, the cap assembly 120 will be coupled to the case 110 to cover the opening 103. Thereafter, the battery cell manufacturing process 1000 according to the present disclosure may perform the chemical process P20.

In the present disclosure, a battery cell 100 may refer to both a battery cell 100 under assembly in the battery cell manufacturing process 1000 according to the present disclosure and a finished battery cell 100 that has completed the battery cell manufacturing process 1000 according to the present disclosure, unless otherwise noted.

FIG. 5 is an example of a battery manufacturing apparatus according to the present disclosure.

A battery manufacturing apparatus 400 according to the present disclosure includes a supporting portion 420 forming a receiving space 428 for receiving a battery cell 100 under assembly, comprising an electrode assembly 20 and a case 110 including the electrode assembly 20 therein, an injector 450 including an injection pipe 451 for moving electrolyte to inject electrolyte into the case 110; and a heater 410 spaced apart from the supporting portion 420 for heating the battery cell 100 under assembly and the injector 450.

The battery cell 100 under assembly may include a case 110, an electrode assembly 20 received within the case 110, and a first current collector 141 and a second current collector 142 electrically coupled to the electrode assembly 20.

The supporting portion 420 may form a receiving space 428 for receiving the battery cell 100 under assembly. In the receiving space 428, the battery cell 100 under assembly may be disposed such that the opening 103 or the injection hole 128 (see FIG. 3) faces the injector 450. Referring now to FIG. 5, there is illustrated an example wherein the terminal portion 130 is oriented downward (see FIG. 1) and the opening 103 is oriented upward. More specifically, FIG. 5 illustrates an example wherein the electrolyte is injected into the case 110 before the cap assembly 120 closes the opening 103. Accordingly, in FIG. 5, the second current collector 142 is exposed to the outside.

The injector 450 may inject the electrolyte into the case 110 through the opening 103 or through the injection hole 128. For this purpose, the injector 450 may comprise a pipe-like injection pipe 451.

Further, the injection pipe 451 may be in the shape of a coil.

The heater 410 may radiate heat toward the receiving space 428.

For example, the heater 410 may irradiate light of an infrared wavelength range toward the battery cell 100 under assembly and the injector 450.

By heating the heater 410, the injector 450 through which the electrolyte travels, and the battery cell 100 under assembly, the viscosity of the electrolyte may be reduced, thereby improving impregnation, which is the degree to which the electrolyte impregnates the electrode assembly 20.

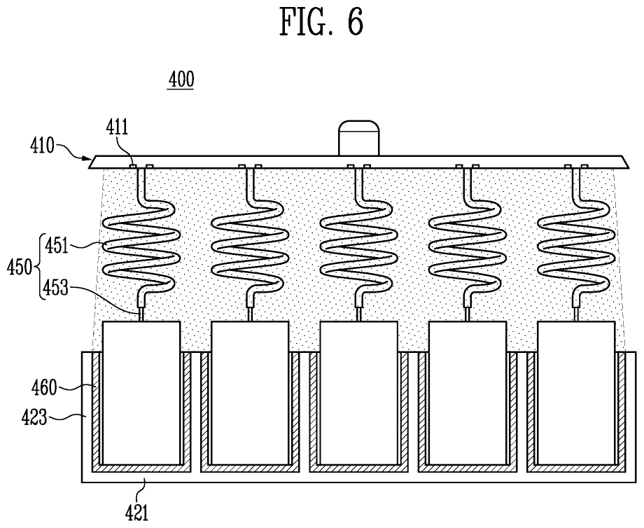

FIG. 6 is another example of a battery manufacturing apparatus according to the present disclosure.

Referring to FIG. 6, the injector 450 and the supporting portion 420 may each be provided in a plurality. Thus, the battery manufacturing apparatus 400 according to the present disclosure can simultaneously inject electrolyte into a plurality of battery cells 100 under assembly.

While FIG. 6 illustrates the heater 410 as being singular, the heater 410 may also be provided in plurality to heat each of the plurality of battery cells 100 under assembly. Alternatively, the heater 410 may comprise a plurality of LED lamps 411 to uniformly heat the plurality of battery cells 100 under assembly, each received by the plurality of supporting portions 420.

The plurality of LED lamps 411 may irradiate light of the infrared wavelength range. Light of the infrared wavelength range may refer to electromagnetic waves in a band with wavelengths longer than visible light perceived by the human eye.

The supporting portion 420 may include a support bottom portion 421 that forms a bottom surface of the receiving space 428, and a support side portion 423 that forms a side of the receiving space 428.

The battery manufacturing apparatus 400 according to the present disclosure may further include a reflective film 460 laminated on an inner surface of the receiving space 428.

More specifically, the supporting portion 420 includes a support bottom portion 421 forming a bottom surface of the receiving space 428, and a support side portion 423 forming a side of the receiving space 428, and the reflective film 460 may be laminated on the support side portion 423 and on the support bottom portion 421.

The reflective film 460 may be a film that reflects infrared light irradiated by the heater 410. The reflective film 460 is intended to reflect the infrared light irradiated by the heater 410 to directly or indirectly heat the battery cell 100 under assembly. In other words, the use of the reflective film 460 rather than an absorbing film that absorbs the infrared radiation irradiated by the heater 410 is intended to minimize the external conditions that can absorb the heat generated by the heater 410, so that the heat is concentrated on the battery cell 100 under assembly. Thus, the use of the reflective film 460 may make it easier to control the temperature than if an absorbing film were used.

The material of the reflective film 460 may be a ceramic-coated PET film. The reflective film 460 may have an infrared reflectance of 90% or more.

Further, the injector 450 may further comprise an injection nozzle 453 connected to the injection pipe 451 for supplying the electrolyte into the case 110 receiving the electrode assembly 20.

The injection pipe 451 may be twisted into a coiled or spring-like shape. Thus, the heater 410 may be able to heat the injection pipe 451 over a relatively larger area than if the injection pipe 451 were a straight pipe. This is to effectively heat the electrolyte moving inside the injection pipe 451.

The reason for heating the battery cell 100 under assembly and the injector 450 through the heater 410 is to increase the temperature of the electrolyte. As the temperature of the electrolyte increases, the ionic conductivity of the electrolyte may increase and the viscosity of the electrolyte may decrease. Thus, the heat exchange performance of the electrolyte may be increased, thereby improving the impregnability of the electrode assembly 20.

Due to the temperature difference between the electrolyte and the battery cell 100 under assembly (in particular the electrode assembly 20), a convergence temperature (or equilibrium temperature, final temperature) may be reached or converged after a certain period of time has elapsed from the injection of the electrolyte. The convergence temperature may be related to the impregnation of the electrolyte.

The heat exchange performance and convergence temperature between the electrolyte and the battery cell 100 (or the electrode assembly 20) under assembly may be expressed by Equation 1 and Equation 2 below.

$${T}_{F i n a l} = {T}_{I n i t i a l} - \sum \frac{{Q}_{H e a {t}_{-} e x c h a n g e}}{{C}_{Electrolyte}} \qquad [ Equation 1 ]$$

$${Q}_{H e a {t}_{-} e x c a h n g e} ∝ \frac{1}{{( {μ}_{Electrolyte} )}^{0.5}} \qquad [ Equation 2 ]$$

In Equation 1 and Equation 2, the T_{Final} represents the convergence temperature of electrolyte (electrode assembly 20 or battery cell 100 under assembly), the Tᵢₙᵢₜᵢₐₗ represents the heating temperature of electrolyte, the Q_{Heat_exchange} represents the heat transfer amount (heat exchange amount) between electrolyte and electrode assembly 20 (or battery cell 100 under assembly), the C_{Electrolyte} represents the heat capacity of electrolyte, and the μ_{Electrolyte} represents viscosity of electrolyte.

Referring to the Equation 2, it can be seen that the amount of heat exchange between the electrolyte and the electrode assembly 20 increases as the viscosity of the electrolyte decrease.

Furthermore, the convergence temperature of the electrolyte considering the heat exchange amount can be calculated by the Equation 1.

Examples of confirming the impregnability according to the convergence temperature of the electrolyte are summarized in Table 1 below.

TABLE 1

| | | Electrolyte | Check for | |
|---|---|---|---|---|
| | Convergence | viscosity at | impregnability at | |
| | Temperature | convergence | convergence | |
| Example | (° C.) | temperature | temperature | Memo |
| Example 1 | 20 | High | Normal | |
| Example 2 | 40 | Good | Good | |
| Example 3 | 60 | Low | High | High |
| | | | | electrolyte |
| | | | | evaporation |
| Example 4 | 80 | Very low | High | Possible |
| | | | | electrolyte |
| | | | | denaturation |

If the convergence temperature of the electrolyte is 20° C. or lower, the viscosity of the electrolyte is high, so it may take a relatively long time for the electrolyte to impregnate the electrode assembly 20. On the other hand, if the convergence temperature of the electrolyte is 60° C. or higher, the initial evaporation of the electrolyte is high, so it may affect the change in the amount of actual filling liquid considering the initial evaporation.

For example, the vapor pressure of an electrolyte based on dimethyl carbonate solvent can increase 2 to 3 times at 60° C. compared to room temperature.

On the other hand, if the convergence temperature of the electrolyte is 80° C. or higher, denaturation problems such as the boiling point of the solvent of the electrolyte and the decomposition of the additives added to the electrolyte may occur.

Thus, referring to Table 1 above, it can be seen that when the convergence temperature or the convergence temperature range or target temperature range to be described later is 40° C. or more but less than 60° C., the viscosity and impregnability of the electrolyte are good for the manufacturing process 1000 of the battery cell.

The temperature of the electrolyte reaching the convergence temperature may be a specific temperature value, but may also mean that the temperature of the electrolyte is maintained within a specific temperature range.

For example, the electrolyte may have a viscosity of 3.0 cP, an ionic conductivity of 9 mS/cm, and a density of 1.2 g/cm³. However, the viscosity, the ionic conductivity, and the density are only examples of the above above-mentioned electrolyte, and the electrolyte referred to herein is not limited thereto.

The experimental method for the embodiment described in Table 1 above is as follows. The viscometer measures the electrolyte viscosity, and the viscosity is expressed as high and low based on the electrolyte viscosity used in the production of the conventional battery cell 100.

Furthermore, the impregnation at the convergence temperature of Table 1 above was confirmed by calculating the surface area of the electrode assembly 20 from the outside to the center by disassembling the electrode assembly 20 immediately after manufacturing the battery cell 100, after 3 hours, after 6 hours, and after 24 hours.

Based on the Equation 1 and the Equation 2, the embodiments carried out under various conditions are summarized in Table 2 below.

TABLE 2

| | Heating | | Convergence | |
|---|---|---|---|---|
| | Temperature(° C.) | Heating | Temperature | |
| | of Electrode | Temperature(° C.) | Reaching Time | Convergence |
| Example | Assembly | of Electrolyte | (min) | temperature(° C.) |
| Example 5 | 35 | 25* | 3.3 | 33.8 |
| Example 6 | 50 | 25* | 5 | 47.1 |
| Example 7 | 60 | 25* | 5.8 | 48 |
| Example 8 | 25* | 40 | 2.9 | 26.8 |

The heating temperature of 25° C. means the room temperature without heating.

By comparing Example 5 to Example 7 in Table 2 above, in order for the electrolyte to come within the convergence temperature or the target temperature range described later at room temperature, it can be seen that the temperature of the electrode assembly 20 or the battery cell 100 being assembly must be higher than that of the electrolyte.

Furthermore, referring to Example 8, it can be seen that without heating the electrolyte and heating the electrode assembly 20, the convergence temperature is not reached due to the difference in heat capacity.

Thus, referring to Table 2, it may be desirable to heat the electrode assembly 20 or the battery cell 100 under assembly. Furthermore, in consideration of the viscosity of the electrolyte injected into the battery cell 100 under assembly, and to reduce the time for heating the electrode assembly 20 or the battery cell 100 under assembly, it may be desirable to heat the electrolyte as well.

The experimental method of the embodiment of Table 2 above is as follows. The electrode assembly 20 may be heated when infrared light is irradiated from the heating section 410, specifically, the plurality of LED lamps 411.

Alternatively, the heater 410 may be heated by direct contact with the injector 450. Alternatively, the electrolyte may be heated to a preset temperature through the heater 410 in a hot chamber before being injected into the case 110.

By positioning the injector 450 within an area irradiated by infrared light through the heater 410, specifically, the plurality of LED lamps 411, the electrolyte can be heated to reach the convergence temperature or the target temperature range before being injected or dosed into the electrode assembly 20.

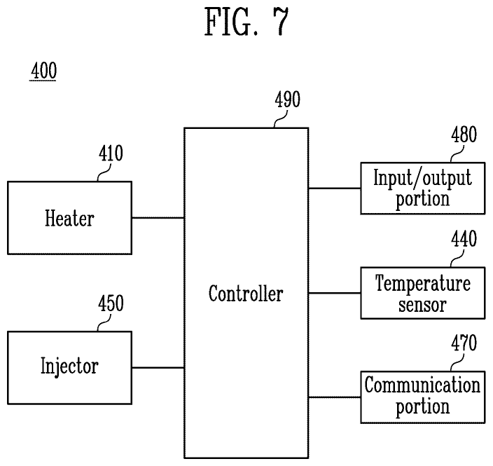

whether the temperature of the electrolyte has reached the convergence temperature or is within the target temperature range, is confirmed by means of a temperature sensor (not shown) on the exterior of the case 110 or by means of a temperature sensor 440 (see FIG. 7) to be described later.

FIG. 7 is a control block diagram of a battery manufacturing apparatus according to the present disclosure.

The battery manufacturing apparatus 400 according to the present disclosure may further comprise a controller 490 that controls the heater 410 and the injector 450.

Further, the battery manufacturing apparatus 400 may further comprise a temperature sensor 440 for measuring the temperature of the receiving space 428, the electrolyte, or the battery cell 100 under assembly. Based on the information obtained through the temperature sensor 440, the controller 490 may be able to adjust the intensity of the light irradiated by the heater 410 or the duration of the light irradiation.

The battery manufacturing apparatus 400 may further include an input/output portion 480 for carrying out commands from an operator and outputting an ongoing status or result, and a communication portion 470 for communicating with the outside.

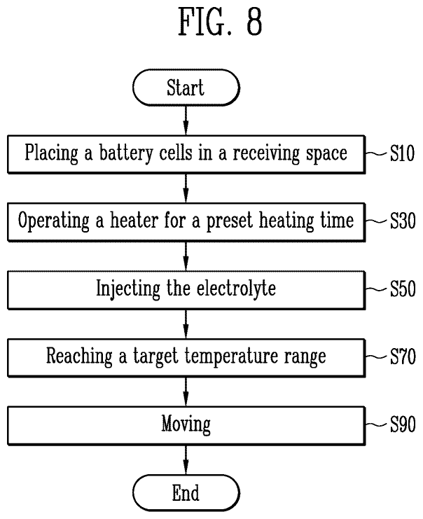

FIG. 8 is a flowchart illustrating a controlling method of a battery manufacturing apparatus according to the present disclosure.

A method of controlling a battery manufacturing apparatus 400 according to the present disclosure may comprise a step S10 of placing a battery cell 100 under assembly, which includes an electrode assembly 20 and a case 110 including the electrode assembly 20 therein, in a receiving space 428 formed by a supporting portion, a step S30 of operating an injector 450 for injecting an electrolyte into the case 110 and a heater 410 for heating for a preset heating time the battery cell 10 under assembly, and a step S50 of injecting the electrolyte into the case 110 through the injector 450.

The method of controlling the battery manufacturing apparatus 400 according to the present disclosure may perform a step S10 of placing the battery cells 100 under assembly in the receiving space 428 to be supported by the supporting portion 420.

In this case, the method of controlling the battery manufacturing apparatus 400 according to the present disclosure may position the battery cell 100 under assembly in the receiving space 428 such that the opening 103 or the cap assembly 120 faces the injector 450, i.e., the terminal portion 130 may be positioned closer to the supporting portion 420 or the support bottom portion 421 than to the injector 450.

After the battery cell 100 under assembly is received in the receiving space, the method of controlling the battery manufacturing apparatus 400 according to the present disclosure may perform a step S30 of operating the heater 410. The heater 410 may irradiate infrared light toward the receiving space 428 to heat the battery cell 100 under assembly and the injector 450.

In the step S30 of operating the heater 410, the heater 410 may heat the battery cell 100 under assembly to a preset first temperature.

In the step S30 of operating the heater 410, the method of controlling the battery manufacturing apparatus 400 according to the present disclosure may perform a step of evacuating air from the inside of the case 110 in order to maintain the inside of the case 110 at a pressure lower than atmospheric pressure. In other words, the battery manufacturing apparatus 400 according to the present disclosure may heat the battery cell 100 and the injector 450 under assembly while simultaneously evacuating air from the inside of the case 110 in order to maintain the pressure of the case 110 at a pressure lower than atmospheric pressure. This is so as to effectively remove even minute remaining air bubbles inside the electrode assembly 20, increase the strength of the injection, and improve the impregnability of the electrolyte.

Prior to the step S50 of injecting the electrolyte, the battery cell 100 under assembly and the injector 450 may be heated to stabilize them at the first temperature. The method of controlling the battery manufacturing apparatus 400 according to the present disclosure aims to shorten the temperature rise time of the electrolyte in the step S50 of injecting the electrolyte and to continuously control the temperature of the electrolyte during the progress of the step S50 of injecting the electrolyte.

The method of controlling the battery manufacturing apparatus 400 according to the present disclosure may supply the electrolyte into the battery cell 100 under assembly through the injector 450. Upon injection of the electrolyte, the method of controlling the battery manufacturing apparatus 400 according to the present disclosure may heat the injector 450 through the heater 410. This is to increase the temperature of the electrolyte.

Furthermore, the controlling method of the battery manufacturing apparatus 400 according to the present disclosure may further comprise a step S70 of making the temperature of the electrolyte reach a preset target temperature range after the step S50 of injecting the electrolyte.

Further, considering Table 1 above, the convergence temperature of the electrolyte or the target temperature range may be range is 40° C. or more but less than 60° C. Since the target temperature range is an equilibrium temperature, it may be the same as the convergence temperature of the battery cell 100 under assembly.

In other words, the method of controlling the battery manufacturing apparatus 400 according to the present disclosure may further comprise a step S70 of making the temperature of the electrolyte reach a preset target temperature range lower than the preset first temperature after the step S50 of injecting the electrolyte.

Further, the method of controlling the battery manufacturing apparatus 400 according to the present disclosure may further comprise a step S90 of moving the battery cell 100 under assembly for charging and discharging after the step S70 of making the temperature of the electrolyte reach a preset target temperature range.

In the step S70 of making the temperature of the electrolyte reach the target temperature range, the method of controlling the battery manufacturing apparatus 400 according to the present disclosure may interrupt the heater 410 to reach the target temperature range within a preset time, or may adjust the intensity of light irradiated through the heater 410.

Specifically, the step S90 of moving the battery cell 100 under assembly for charging and discharging may comprise the step of cooling the battery cell 100 under assembly to a temperature lower than the target temperature range.

Alternatively, between the step of reaching the target temperature range S70 and the step of moving the battery cell 100 under assembly S90 for charging and discharging, the method of controlling the battery manufacturing apparatus 400 according to the present disclosure may also include the step of cooling the battery cell 100 under assembly to a temperature lower than the target temperature range.

Cooling the battery cell 100 under assembly to a temperature lower than the target temperature range may be accomplished by resting the electrolyte-filled battery cell 100 at room temperature, rather than utilizing a separate cooling device.

As mentioned above, the electrolyte may be injected through the injection hole 128 after the cap assembly 120 is coupled to the case 110, but before the injection hole 128 is closed. Alternatively, however, the electrolyte may be injected into the case 110 through the opening 103 before the cap assembly 120 is coupled thereto.

Thus, the method of controlling the battery manufacturing apparatus 400 according to the present disclosure may further comprise a step of coupling a cap assembly 120 to the case 110 in order to cover the opening 103 formed on a side of the case 110 facing the direction in which the electrolyte is injected prior to the step S90 of moving the battery cell 100 under assembly for charging and discharging.

Alternatively, the method of controlling the battery manufacturing apparatus 400 according to the present disclosure may further comprise a step of coupling a cap assembly 120 including an injection hole 128 to the case 110 to cover an opening 103 formed on a side of the case 110 prior to the step S50 of injecting the electrolyte into the case 110.

The above description of the present disclosure is for illustrative purposes only, and a person skilled in the art to which the present disclosure pertains will understand that the present disclosure may be easily modified into other specific forms without changing the technical idea or essential features of the present disclosure. Therefore, it should be understood that the embodiments described above are exemplary in all respects and not limiting. For example, each component described as a single entity may be implemented in a distributed manner, and likewise, components described as distributed may be implemented in a combined manner.

The scope of the present disclosure is indicated by the appended claims rather than the detailed description above, and all changes or modifications derived from the meaning and scope of the claims and their equivalent concepts should be construed as being included in the scope of the present disclosure.

What is claimed is:

1. A battery manufacturing apparatus comprising:
a supporting portion forming a receiving space for receiving a battery cell under assembly, the battery cell including an electrode assembly and a case including the electrode assembly therein;
an injector including an injection pipe for moving an electrolyte to inject the electrolyte into the case; and
a heater spaced apart from the supporting portion for heating the battery cell under assembly and the injector.

2. The battery manufacturing apparatus according to claim 1, wherein the heater irradiates light of an infrared wavelength range toward the battery cell under assembly and the injector.

3. The battery manufacturing apparatus according to claim 2, wherein the supporting portion includes a support bottom portion forming the bottom surface of the receiving space and a support side portion forming the side surface of the receiving space.

4. The battery manufacturing apparatus according to claim 2, further comprising:
a reflective film laminated on an inner surface of the receiving space.

5. The battery manufacturing apparatus according to claim 4, wherein the supporting portion includes a support bottom portion forming the bottom surface of the receiving space and a support side portion forming the side surface of the receiving space, and
wherein the reflective film is coated on the support side portion and the support bottom portion.

6. The battery manufacturing apparatus according to claim 1, wherein the injection pipe is in the shape of a coil.

7. The battery manufacturing apparatus according to claim 1, wherein the injector further includes an injection nozzle connected to the injection pipe and supplies the electrolyte into the case receiving the electrode assembly.

8. A method of controlling a battery manufacturing apparatus comprising:
a step of arranging a battery cell under assembly, which includes an electrode assembly and a case including the electrode assembly therein, in a receiving space formed by a supporting portion;
a step of operating an injector for injecting an electrolyte into the case and a heater for heating the battery cell under assembly; and
a step of injecting the electrolyte into the case through the injector.

9. The method of controlling a battery manufacturing apparatus according to claim 8, further comprising:
a step of making the temperature of the electrolyte reach a preset target temperature range after the step of injecting the electrolyte.

10. The method of controlling a battery manufacturing apparatus according to claim 9, wherein the target temperature range is 40° C. or more but less than 60° C.

11. The method of controlling a battery manufacturing apparatus according to claim 9, further comprising:
a step of moving the battery cell under assembly for charging and discharging after the step of making the temperature of the electrolyte reach a preset target temperature range.

12. The method of controlling a battery manufacturing apparatus according to claim 11, further comprising:
a step of coupling a cap assembly to the case to cover an opening formed on a side of the case facing the direction in which the electrolyte is injected prior to the step of moving the battery cell under assembly for charging and discharging.

13. The method of controlling a battery manufacturing apparatus according to claim 11, wherein the step of moving the battery cell under assembly for charging and discharging includes a step of cooling the battery cell under assembly to a temperature lower than the target temperature range.

14. The method of controlling a battery manufacturing apparatus according to claim 8, further comprising:
a step of coupling a cap assembly including an injection hole to the case to cover an opening formed on a side of the case prior to the step of injecting the electrolyte into the case.

15. The method of controlling a battery manufacturing apparatus according to claim 8, wherein the heater heats the battery cell under assembly to a preset first temperature in the step of operating the heater.

16. The method of controlling a battery manufacturing apparatus according to claim 15, further comprising:
a step of making the temperature of the electrolyte reach a target temperature range lower than the preset first temperature after the step of injecting the electrolyte.
